(19) United States
(12) Patent Application Publication
(10) Pub. No.: US 2014/0098625 A1
(43) Pub. Date: Apr. 10, 2014

(54) CONCRETE MIXER APPARATUS

(71) Applicant: Brinsley McFarlane, Carmichael (GB)

(72) Inventor: Brinsley McFarlane, Carmichael (GB)

(21) Appl. No.: 14/124,229

(22) PCT Filed: Jun. 11, 2012
(86) PCT No.: PCT/GB2012/000506

§ 371 Date: Dec. 5, 2013

(30) Foreign Application Priority Data
Jun. 9, 2011 (GB) 1109664.1
Nov. 3, 2011 (GB) 1118950.3
Nov. 14, 2011 (GB) 1119524.5
Feb. 28, 2012 (GB) 1203481.7
Mar. 1, 2012 (GB) 1203655.4

(51) Int. Cl. B28C 5/42

(52) U.S. Cl. CPC B28C 5/4248
USPC 366/68

(57) ABSTRACT

An apparatus (10) for a lorry-based concrete mixer (12) is described. The apparatus (10) comprises a vessel (14) adapted to be positioned beneath a concrete mixer discharge chute portion (22) when the discharge chute (20) is in a stowed position. In use, the vessel (14) is adapted to receive and retain debris exiting the discharge chute portion (22). In at least one embodiment, the vessel (14) is adapted to receive and retain debris and fluid exiting the discharge chute portion (22).

### FIELD OF THE INVENTION

The present invention relates to an apparatus for a lorry based concrete mixer. Particularly, but not exclusively the apparatus relates to an apparatus for catching debris which may bounce out of the drum of a lorry based concrete mixer during transit.

### BACKGROUND TO THE INVENTION

Lorry-based concrete mixers are supplied with a movable discharge chute which can be positioned in various configurations to allow the discharge of concrete from the mixer drum. When not in use, and particularly when the vehicle is in transit, the chute is swung to a stowed position.

In the stowed position, there is the possibility that any loose stones within the mixer drum can bounce down the chute onto the road. As the stone will be moving at speed, it has the potential to bounce and strike another vehicle causing damage. This has been partially alleviated, in some cases, by the incorporation of a flap mounted to the chute. The flap is positioned to prevent stones leaving the chute during transit and is moved out of the way to allow for the discharge of concrete when required. One of the drawbacks of this arrangement is that this is known for the flap to be permanently located in the discharge position obviating the benefit of the chute; permitting stones to run down the chute during transit.

In the stowed position, there is also the possibility over time that the brackets holding the chute in the stowed position can come loose with the result that the chute can potentially swing away from the discharge position towards a vehicle following the mixer.

### SUMMARY OF THE INVENTION

According to a first aspect of the present invention there is provided an apparatus for a lorry-based concrete mixer, the apparatus comprising:

a vessel adapted to be positioned beneath a concrete mixer discharge chute portion when the discharge chute is in a stowed position, the vessel being adapted, in use, to receive and retain debris exiting the discharge chute portion.

Such an arrangement, in at least one embodiment of the present invention, permits debris to be captured and stored during transit, the stowed position being the position the chute is secured in for transit.

The apparatus may be adapted to receive and retain liquid debris such as slurry or wash down water.

The vessel may be adapted to receive the discharge chute portion within a vessel interior.

The discharge chute portion may be an end of the discharge chute.

The vessel may be adapted to at least partially encircle the discharge chute portion.

The vessel may be adapted to fit snugly around the discharge chute.

The vessel may be adapted to be pivotally mounted to a lorry-based concrete mixer.

The vessel may, in use, be movable between a disengaged and an engaged position, in the engaged position, the vessel being engaged with the discharge chute portion and securing the discharge chute in the stowed position.

The vessel may be lockable to the discharge chute portion.

The vessel may be movable about the pivotal mounting.

Alternatively, the vessel may, in use, be adapted to be fixed relative to a lorry-based concrete mixer. The vessel may be removable from the lorry-based concrete mixer. In this embodiment, the chute portion may be positioned adjacent the vessel, particularly the end of the discharge chute may be positioned adjacent the vessel.

In a preferred embodiment, the discharge chute portion may, in use, be positioned above the vessel.

In an embodiment, the chute portion may be lowered towards and/or into vessel, particularly the discharge chute portion may be lowered into the vessel.

The apparatus may further comprise securing means adapted to secure the discharge chute to a lorry-based concrete mixer. The securing means may be a mechanism adapted to secure the discharge chute to a frame or chassis of the lorry-based concrete mixer. The securing mechanism may be adapted to secure the discharge chute end over the vessel.

The securing mechanism may be a male member attached to one of the discharge chute or, in use, a frame or chassis of the lorry-based concrete mixer and a female member attached to the other of the discharge chute or frame or chassis of the lorry-based concrete mixer.

The male and female member, once engaged, may be arranged to prevent movement of the discharge chute in a horizontal plane. Such an arrangement prevents the discharge chute from swinging from the stowed position to the discharge position. The securing means may be the primary method of securing the discharge chute in the stowed position.

The male member may be a peg and a female member may be a loop. In an embodiment, as the chute is lowered into or towards the vessel, the peg passes into the loop. The peg may be a tapered peg.

The vessel may comprise a substantially transparent portion. A transparent portion allows a user to inspect the chute without needing to remove the vessel from the end of the chute.

The vessel may be adapted to be removably received within a cradle defined by a lorry-based concrete mixer chassis.

The vessel may comprise an outlet. An outlet may be provided to allow the vessel to be emptied.

The apparatus may further comprise an outlet grill or the like adapted to prevent larger pieces of debris from passing through the outlet.

The apparatus may further comprise a storage container.

The vessel may be in communication with the storage container such that debris can pass through the vessel outlet into the storage container.

The storage container and the vessel outlet may be connected by means of a conduit. Providing a storage container which can be located in space between, for example, the rear wheels, allows the size of the vessel to be reduced whilst still permitting the apparatus as a whole to deal with the debris coming down the chute.

The storage container may be adapted to hold fluid. In some embodiments, the vessel is in fluid communication with the storage container. Such an arrangement permits the vessel to be washed in the event of, for example, a discharge of slurry into the vessel, the slurry being flushed into the storage container. The apparatus can also be used to wash the discharge chute after depositing a load of concrete. After depositing, the discharge chute generally contains some debris which, if not removed relatively quickly, hardens, leading to further more prolonged cleaning. The arrangement of the present invention stops the fluid being washed into the public drains or onto the public highway.

The vessel may be adapted to receive the subsidiary discharge chutes. In addition to the main discharge chute, a number of additional chutes are provided to allow the mixer to discharge into different receptacles or receptacles placed in different locations.

In this stowed configuration, one or more additional chutes can be positioned around the end of the discharge chute. In one embodiment, the additional chutes can be used to provide a further shroud around the end of the discharge chute, ensuring that debris coming down the discharge chute is deflected into the vessel.

Alternatively or additionally, the vessel may be adapted to receive the subsidiary discharge chutes in the disengaged position.

In one embodiment, where the vessel is pivotally mounted to a lorry-based concrete mixer, in the disengaged position, the vessel may be rotated 90° in a horizontal plane from the engaged position. In this position, with the vessel opening facing backwards, it is relatively straightforward to hook one of the discharge chutes to the vessel for cleaning.

The vessel may be provided with attachment means to support a discharge chute such that the chute is supported by the vessel during cleaning.

The vessel may define a mouth.

The mouth may define a tapered surface, particularly an internal tapered surface.

The mouth may be adapted to receive a number of different sizes of discharge chute portions. Such an arrangement provides additional utility as one size of vessel can accommodate a number of sizes of discharge chute portions and, therefore, there is a reduced requirement for stock holdings.

The vessel may have an internal surface adapted for forming a seal with the end of the discharge chute portion. Such an arrangement provides utility for the user because a form of seal between the chute portion and the vessel will reduce the possibility of debris and/or liquid leaking away from the vessel. This is of particular utility during transit of specialised concretes that are very fluid, as used in the construction of, for example, self-levelling floor concretes. Whilst this concrete is in transit it is possible, due to it being so fluid, for the concrete to splash out the back, when, for example, the delivery truck requires stopping suddenly whilst travelling up hill. As the brakes are applied, the momentum of the concrete continues forward resulting in the concrete rebounding off the forward dished end, this results in a back wave which can spill onto the road. In an embodiment of the present invention, this is prevented by the apparatus.

According to a second aspect of the present invention there is provided an apparatus for a lorry-based concrete mixer, the apparatus comprising:

a vessel adapted to receive a portion of a concrete mixer discharge chute, in use, securing the discharge chute in a chute stowed position, the vessel, when engaged with the discharge chute portion, being adapted to receive and retain debris exiting the discharge chute portion.

In an embodiment of the invention, an apparatus is provided which both secures a discharge chute in a chute stowed position and prevents debris leaving the chute from entering the surrounding environment and potentially causing damage. Such a system prevents the debris catching aspect being bypassed as it is inherent within the securing feature.

According to a third aspect of the present invention there is provided an apparatus for a lorry-based concrete mixer, the apparatus comprising:

a vessel adapted to receive an end of a concrete mixer discharge chute;

wherein, in use, when the discharge chute portion is received within the vessel, the vessel is positioned to receive and retain debris exiting the discharge chute portion.

According to a fourth aspect of the present invention, there is provided a method of washing down a concrete mixer discharge chute, the method comprising the steps of:

moving the discharge chute to a stowed position; and

washing the discharge chute, fluid from the discharge chute exiting a discharge chute portion into a vessel positioned beneath the discharge chute portion.

It will be understood that features listed as being non-essential with respect to any of the above aspects may be applicable to the any of the other aspects and are not repeated for brevity.

### BRIEF DESCRIPTION OF THE DRAWINGS

Embodiments of the present invention will now be described with reference to the Figures, in which:

FIG. 1 is a side view of an apparatus for a lorry-based concrete mixer according to a first embodiment of the present invention; and

FIG. 2 is a close-up view of part of the apparatus of FIG. 1.

FIG. 3 is a first perspective view of an apparatus for a lorry-based concrete mixer according to a second embodiment of the present invention; and

FIG. 4 is a second perspective view of the apparatus of FIG. 3.

### DETAILED DESCRIPTION OF THE DRAWINGS

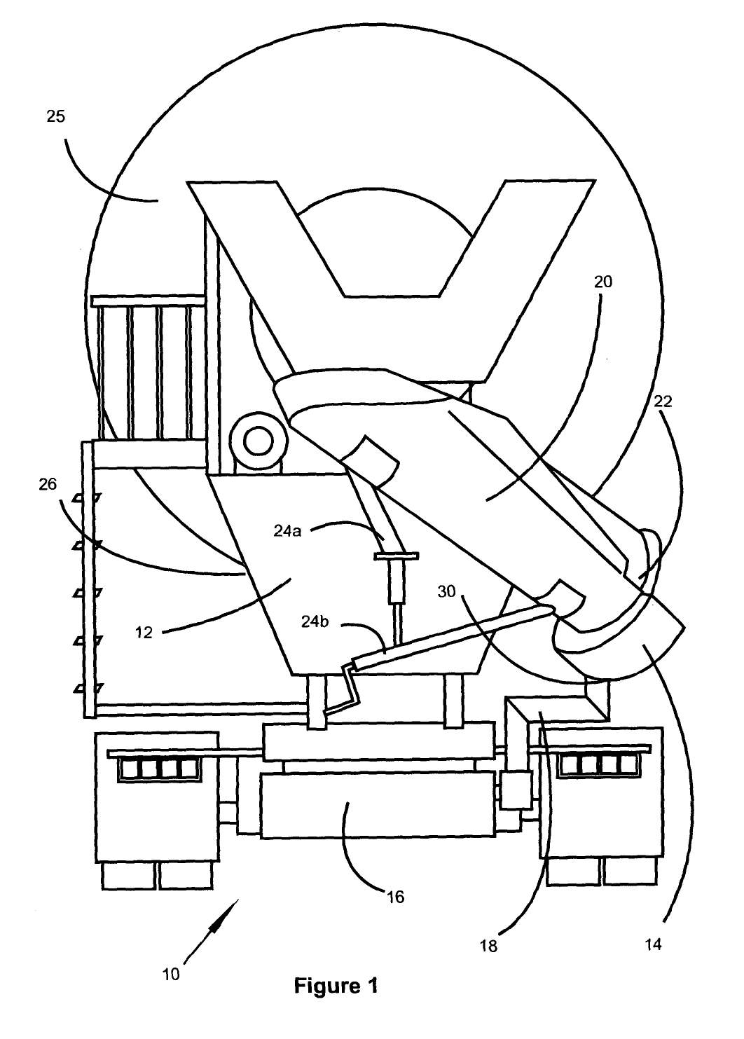

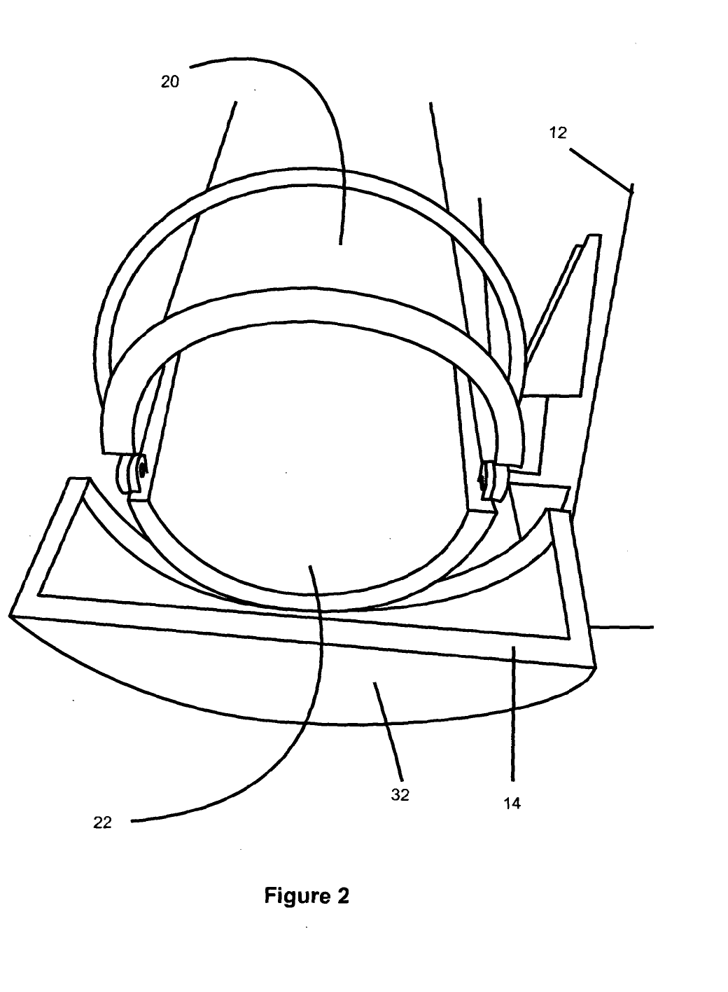

A first embodiment of the present invention will now be described with reference to FIGS. 1 and 2, showing a side view of an apparatus, generally indicated by reference numeral 10, for a lorry-based concrete mixer 12 and a close-up view of part of the apparatus 10 of FIG. 1 respectively.

The apparatus 10 comprises a vessel 14 connected to a storage container 16 by a pipe 18. The storage container 16 and pipe 18 are mounted to a lorry-based concrete mixer 12. The concrete mixer 12 includes a drum 25, a mixer body 26 and a discharge chute 20 having an outlet 22. The discharge chute 20 is movable relative to the mixer body 26 and is shown in FIGS. 1 and 2 in a stowed position in which it is swung close to the mixer body 26. As can be seen, in this position, the chute outlet 22 is secured within the vessel 14. Particularly, in this position, the chute 20 cannot swing away from the stowed position should there be a failure in the brackets 24A, 24B, securing the chute to the mixer body 26. In this stowed position, and particularly after discharge of concrete, the chute 20 can be washed down, the washing water being captured within the vessel 14 and fed through a vessel outlet 30 into the storage container 16 via the pipe 18.

Referring particularly to FIG. 2, the vessel 14 includes a back plate 32 which, in use, prevents debris which may exit the chute outlet 22, from leaving the vicinity of the mixer 12 by catching it and retaining it within the vessel 14.

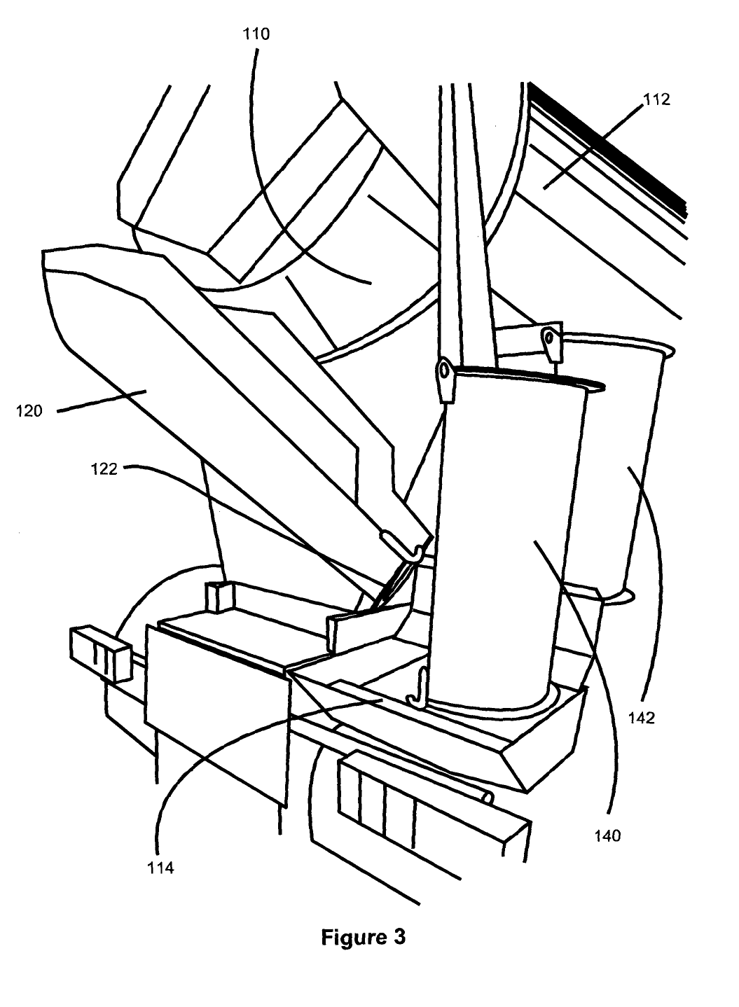

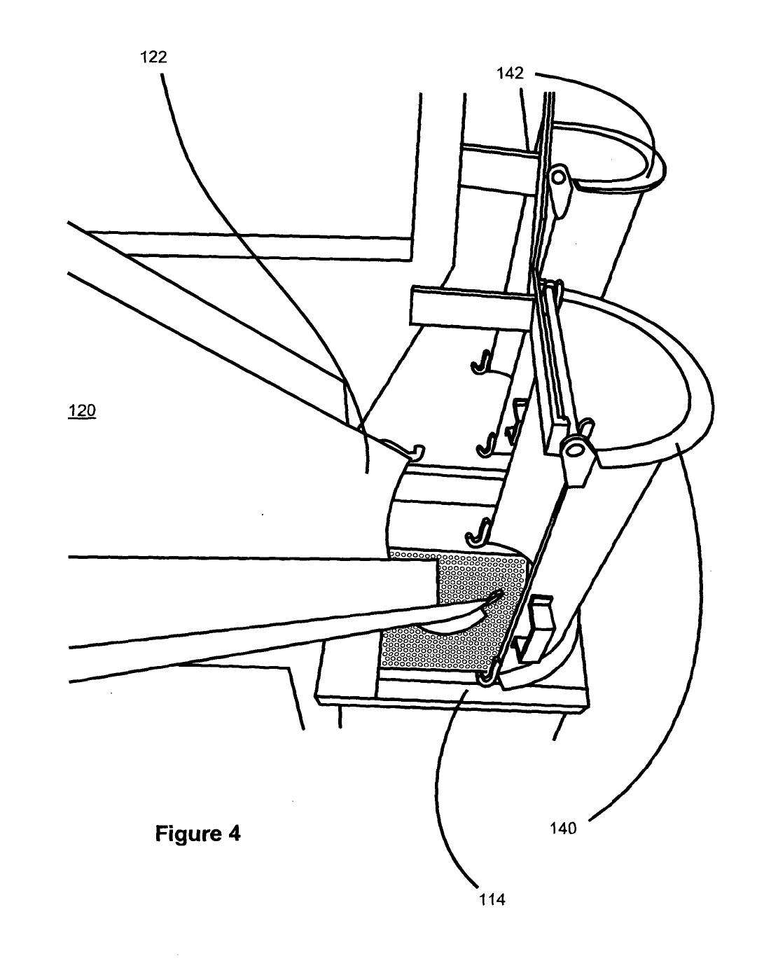

Referring to FIGS. 3 and 4, a first and a second perspective views of an apparatus 110 for a lorry-based concrete mixer, a slightly different arrangement is that shown for the apparatus 10 of FIGS. 1 and 2. In this apparatus 110, the discharge chute outlet 122 sits above the vessel 114 and debris exiting the lorry-based concrete mixer 112 will fall off the end 122 of the discharge chute and fall into the vessel 114. A secondary chute 140 which, in use, is attachable to the chute outlet 122 to provide extra utility when depositing concrete, is, in this stowed position, positioned around the chute outlet 122 to deflect debris, which may otherwise miss the vessel 114, into the vessel 114. In this position, the secondary chute 140 can also be cleaned with the washing water being captured within the vessel 114. A third chute 142 is also shown in the stowed position displaced from the vessel 114 however in further embodiments, this third chute 142 may also be positioned around the chute outlet 122 to deflect debris.

It will be seen that the apparatus provides utility by securing the chute in the stowed position, preventing debris exiting the chute and causing damage and by providing a means of storing waste water which has been used to wash down the chute.

It will be understood that modifications and improvements may be metres above described embodiments without departing from the scope of the invention.

1. An apparatus for a lorry-based concrete mixer, the apparatus comprising:
a vessel adapted to be positioned beneath a concrete mixer discharge chute portion when the discharge chute is in a stowed position, the vessel being adapted, in use, to receive and retain debris exiting the discharge chute portion whilst the lorry-based concrete mixer is in motion, the vessel being further adapted to receive wash down water.

2. (canceled)

3. The apparatus of claim 1, wherein the discharge chute portion is an end of the discharge chute.

4. The apparatus of claim 3, wherein the apparatus comprises a securing means adapted to secure the discharge chute to a lorry-based concrete mixer in the stowed position.

5. The apparatus of claim 4, wherein the securing means is a securing mechanism adapted to secure the discharge chute to a frame or chassis of the lorry-based concrete mixer.

6. The apparatus of claim 5, wherein the securing mechanism is adapted to secure the discharge chute end over the vessel.

7. The apparatus of claim 1, wherein the vessel comprises vessel outlet.

8. The apparatus of claim 7, wherein the apparatus further comprises a storage container.

9. The apparatus of claim 8, wherein the storage container is adapted to hold fluid.

10. The apparatus of claim 9, wherein the vessel is in fluid communication with the storage container such that debris and/or fluid can pass through the vessel outlet into the storage container.

11. The apparatus of claim 10, wherein the storage container and the vessel outlet are connected by means of a conduit.

12. The apparatus of claim 7, wherein the apparatus further comprises an outlet grill or the like adapted to prevent larger pieces of debris from passing through the outlet.

13. The apparatus of claim 1, wherein the vessel is adapted to receive and retain debris falling from the discharge chute portion.

14. The apparatus of claim 1, wherein the vessel is adapted to receive the discharge chute portion within a vessel interior.

15. The apparatus of claim 1, wherein in the stowed position, the discharge chute portion is, in use, positioned above the vessel.

16. The apparatus of claim 1, wherein in the stowed position, the chute portion is lowered towards and/or into vessel, particularly the discharge chute portion is lowered into the vessel.

17. The apparatus of claim 1, wherein the apparatus further comprises a storage means adapted to secure an at least one secondary chute in the stowed position.

18. The apparatus of claim 17, wherein the storage means is adapted to secure the at least one secondary chute adjacent the discharge chute portion.

19. The apparatus of claim 17, wherein the storage means is adapted to position the at least one secondary chute such that debris and/or fluid exiting the discharge chute portion is directed towards the vessel.

20. The apparatus of claim 17, wherein the storage means, in use, suspends the at least one secondary chute above the vessel.

21. The apparatus of claim 17, wherein the storage means is adapted to secure the at least one secondary chute in both the stowed position and a discharge position.

22. The apparatus of claim 5, wherein the securing mechanism is a male member attached to one of the discharge chute or, in use, a frame or chassis of the lorry-based concrete mixer and a female member attached to the other of the discharge chute or frame or chassis of the lorry-based concrete mixer.

23. The apparatus of claim 22, wherein the male and female member, once engaged, is arranged to prevent movement of the discharge chute in a horizontal plane.

24. The apparatus of claim 1, wherein the vessel is, in use, adapted to be fixed relative to a lorry-based concrete mixer.

25. The apparatus of claim 24, wherein the vessel is, in use, removably fixed to the lorry-based concrete mixer.

26. The apparatus of claim 25, wherein the vessel is adapted to be removably received within a cradle defined by a lorry-based concrete mixer chassis.

27. (canceled)
